(19) United States
(12) Patent Application Publication
(10) Pub. No.: US 2024/0211780 A1
(43) Pub. Date: Jun. 27, 2024

(54) INFERENCE METHOD USING A DNN MODEL IN ENERGY HARVESTING SYSTEM

(71) Applicant: Research & Business Foundation SUNGKYUNKWAN UNIVERSITY, Suwon-si (KR)

(72) Inventors: Euiseong SEO, Suwon-si (KR); Gwanjong PARK, Suwon-si (KR); Osama KHAN, Suwon-si (KR)

(73) Assignee: Research & Business Foundation SUNGKYUNKWAN UNIVERSITY, Suwon-si (KR)

(21) Appl. No.: 18/544,678

(22) Filed: Dec. 19, 2023

(30) Foreign Application Priority Data
Dec. 21, 2022 (KR) 10-2022-0180368

(51) Int. Cl. G06N 5/04; G06N 3/04

(52) U.S. Cl. CPC G06N 5/04; G06N 3/04

(57) ABSTRACT

An inference method using a DNN model in an energy harvesting system according to a first characteristic of the present disclosure comprises performing energy harvesting and storing energy in a storage; receiving a request for inference using data collected during the period of energy harvesting; selecting one DNN model to perform the inference among a plurality of DNN models; performing the inference through the selected DNN model; and performing energy harvesting again when the inference is completed and storing energy in the storage, wherein the plurality of DNN models are DNN models with different inference accuracy and energy consumption required for inference, and the selecting of the DNN model is performed by an agent through an action based on the state of energy stored in the storage. Accordingly, the present disclosure allows dynamic selection of a DNN model with a suitable structure for each inference request by considering the continuously changing amount of harvested energy.

### TECHNICAL FIELD

The present disclosure relates to an inference method using a DNN model in an energy harvesting system and, more particularly, to an inference method using a DNN model in an energy harvesting system, which loads DNN models with different inference accuracy and energy consumption required for inference and selects a DNN model to perform inference according to a learned policy in the occurrence of an inference event.

### BACKGROUND

The energy harvesting environment is characterized by a limited amount of available energy and the absence of a guarantee for continuous power supply. Meanwhile, using a deep neural network (DNN) for inference has the advantage of achieving high accuracy compared to other machine learning algorithms but also brings a drawback of demanding a significant amount of energy. Therefore, it is challenging to apply the inference process based on a DNN directly to an energy harvesting system utilizing harvested energy as a power source.

In the energy harvesting environment, performing inference using only a single DNN structure is inefficient in terms of energy management and performance. The inference accuracy of a DNN model varies depending on its structure, and a DNN model constructed with a more complex structure tends to exhibit higher accuracy. If a DNN employs a model structure that achieves a low error rate in the inference result but consumes a significant amount of energy, harvested energy is often depleted before the completion of inference, which increases the inference failure rate. On the other hand, if a DNN employs a model structure with a relatively high error rate in the inference result but low energy consumption, the inference failure rate decreases, but at the cost of frequent occurrence of false inference results, increasing the amount of wasted energy.

In the energy harvesting environment, the amount of energy obtained per unit time changes continuously, making it difficult to predict the changes; therefore, there needs a method for selecting one DNN model with an appropriate structure in terms of energy management and performance among various DNN structures.

### SUMMARY

To solve the problem of the prior art described above, the present disclosure provides an inference method using a DNN model in an energy harvesting system, which loads DNN models with different inference accuracy and energy consumption required for inference and selects a DNN model to perform inference according to a learned policy in the occurrence of an inference event.

An inference method using a DNN model in an energy harvesting system according to a first characteristic of the present disclosure comprises performing energy harvesting and storing energy in a storage; receiving a request for inference using data collected during the period of energy harvesting; selecting one DNN model to perform the inference among a plurality of DNN models; performing the inference through the selected DNN model; and performing energy harvesting again when the inference is completed and storing energy in the storage, wherein the plurality of DNN models are DNN models with different inference accuracy and energy consumption required for inference, and the selecting of the DNN model is performed by an agent through an action based on the state of energy stored in the storage.

A recording medium readable by a digital processing device, in which a program of commands executed by the digital processing device to provide inference using a DNN model in an energy harvesting system according to a second characteristic of the present disclosure is implemented, records a program for executing an inference method using a DNN model in the energy harvesting system according to the first characteristic of the present disclosure in a computer.

An inference method using a DNN model in an energy harvesting system according to an embodiment of the present disclosure provides the following effects.

The inference method loads DNN models with different inference accuracy and energy consumption required for inference and selects a DNN model to perform inference according to a learned policy in the occurrence of an inference event, and learning a policy allows dynamic selection of a DNN model with a suitable structure for each inference request in consideration of the continuously changing amount of harvested energy by minimizing the inference failure rate index and the average inference result error rate index through reinforcement learning, eventually providing an application with improved reliability and quality.

### BRIEF DESCRIPTION OF THE DRAWINGS

FIG. 1 is a conceptual flow diagram illustrating an inference method using a DNN model in an energy harvesting system according to an embodiment of the present disclosure.

FIG. 2 is a flow chart of an inference method using a DNN model in an energy harvesting system according to an embodiment of the present disclosure.

FIG. 3 is a table showing information of DNN models configured for an experiment according to one embodiment of the present disclosure.

FIG. 4 are graphs showing the average rewards of reinforcement learning for model selection due to the difference between power sources for energy harvesting according to one embodiment of the present disclosure.

FIG. 5 is a graph showing measurements of metric values for each application in a situation where solar energy is harvested according to one embodiment of the present disclosure.

FIG. 6 is a graph showing measurements of metric values for each application in a situation where wind energy is harvested according to one embodiment of the present disclosure.

### DETAILED DESCRIPTION

In what follows, the present disclosure will be described in detail with reference to embodiments and appended drawings. However, it should be noted that the detailed description is not intended to limit the present disclosure to the specific embodiment; also, if it is determined that a detailed description of the prior art related to the present disclosure obscures the gist of the present disclosure, the detailed description thereof will be omitted.

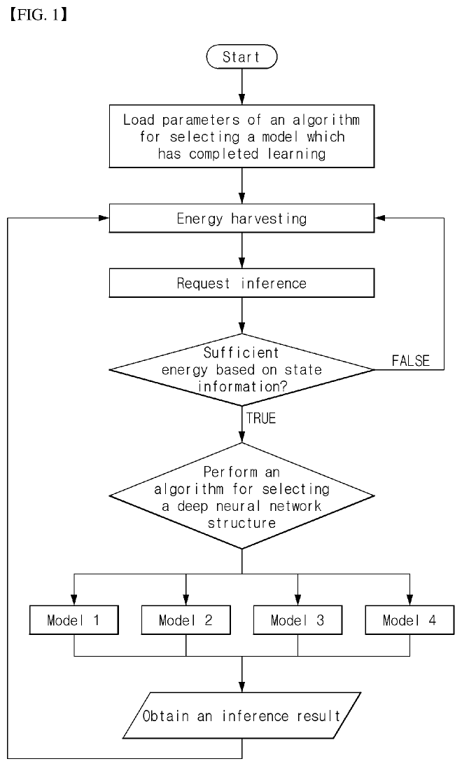

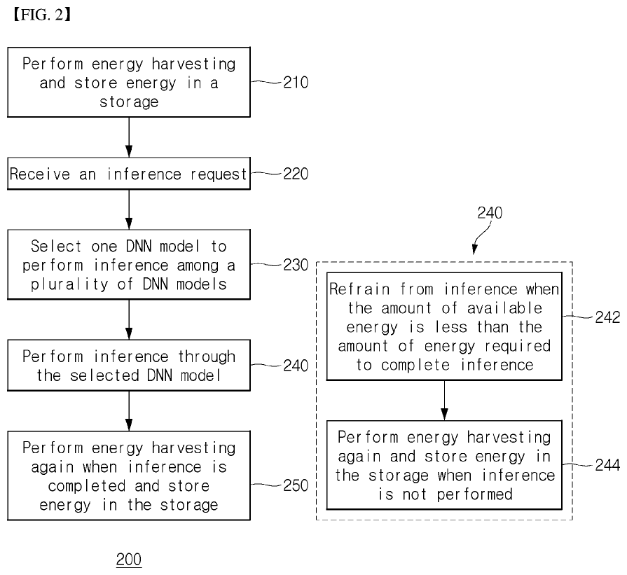

FIGS. 1 and 2 are a conceptual flow diagram and a flow chart illustrating an inference method using a DNN model in an energy harvesting system according to an embodiment of the present disclosure.

According to an embodiment of the present disclosure, the inference method 200 using a DNN model in an energy harvesting system may comprise performing energy harvesting and storing energy in a storage 210, receiving a request for inference using data collected during the period of energy harvesting 220, selecting one DNN model to perform the inference among a plurality of DNN models 230, performing the inference through the selected DNN model 240, and performing energy harvesting again when the inference is completed and storing energy in the storage 250.

Also, according to an embodiment of the present disclosure, the performing of the inference through the selected DNN model 240 may include refraining from inference if it is determined that the amount of energy required to complete the inference through the selected DNN model is greater than the amount of energy stored in the storage 242 and performing energy harvesting again and storing energy in the storage if the inference is not performed 244.

According to an embodiment of the present disclosure, the plurality of DNN models are DNN models with different inference accuracy and energy consumption required for inference.

According to an embodiment of the present disclosure, the selecting of one DNN model 230 may select one DNN model by an agent through an action based on the state of energy stored in the storage according to a policy.

Accordingly, as an energy harvesting device performing inference using a local deep neural network (DNN) dynamically selects a model with a DNN structure suitable for the harvesting state, it becomes possible to provide an application with improved reliability and quality.

The policy for the dynamic selection of a DNN model is determined through reinforcement learning, with the objective of minimizing the inference failure rate index and the average inference result error rate index. The inference failure rate is computed as the number of times inference fails to be completed divided by the number of times inference is requested during a specific period, and the average inference result error rate is computed as the average error rate of the selected DNN models for the cases in which inference is completed during a specific period.

If the rate of erroneous assessment of energy consumption for the inference process is high, the energy wasted from the erroneous assessment has a significant influence on the performance of the energy harvesting system. To enable the control of energy usage through diverse DNN structures, DNN models employing different structures, each with a different level of inference accuracy and energy consumption required for inference, are built and loaded into a microcontroller through learning and compression processes.

The energy harvesting device is requested to perform inference on the data obtained through sensing during a predetermined energy harvesting period (e.g., collecting solar energy while the sun is up). After selecting the DNN model for inference, the energy harvesting device proceeds with inference using the selected model. When inference is completed, energy is harvested again until the next inference request is received. If inference may not be completed using the selected model, the energy harvesting device does not start the inference process.

First, the harvesting state is defined, which serves as a basis for determining the amount of energy used when an inference request is received. The harvesting state is defined so that effective decision-making may be made based solely on the information obtained at time step t within an episode during the reinforcement learning process. In other words, if the harvesting state being defined is considered an environmental state, the state satisfies the Markov assumptions, and the features requiring computation within the state minimize the cost.

The designed state consists of four consecutive features. The first feature constituting the state is information on the amount of energy stored in the energy storage, which serves as a criterion for determining the amount of available energy. The range of the first feature is defined by positive values, with its maximum corresponding to the amount of energy that may be stored in the energy storage. The second feature constituting the state is information on the amount of energy harvested during the interval up to the previous time step. The third feature constituting the situation is information on the average amount of energy harvested during the period comprising last 10 time steps. Through the second and third features, it becomes possible to identify trends in the quantity of energy harvested as time progresses. The final feature constituting the state is information obtained by subtracting the average value of the quantity of energy stored during the period comprising three oldest time steps from the average value of the quantity of energy stored during the period comprising three most recent time steps within a period comprising last 10 time steps. For example, the final feature may be the information obtained by subtracting the average value of the quantity of energy stored at time steps t-8, t-9, and t-10 from the quantity of energy stored at time steps t-1, t-2, and t-3. Through the information on the features, it becomes possible to identify trends in the amount of change in energy harvested over time.

Based on the state containing the harvesting history, the agent selects one of various DNN models, ranging from a DNN model with relatively low energy consumption to one with high energy consumption, through an action. The action space comprises as many spaces as the number of loaded DNN models, and the agent selects one model through a discrete action. Among the models, a model with relatively low inference accuracy generally has a relatively simple structure, demands a small number of computations for inference, and consumes a low amount of energy required for data movement. Meanwhile, the energy required to proceed with model inference has to be lower than the maximum amount of energy that the energy storage may be charged with.

The objective of reinforcement learning is to maximize the cumulative sum of designed rewards. Therefore, rewards are designed to minimize instances in which an inference failure occurs due to the inability of an agent involved in model selection policy learning to use the energy within a budgeted overhead in an episode and to minimize the average inference result error rate calculated based on model selection.

At time step t, the agent selects one of the loaded DNN models and takes an action. Inference is made on the sensed data through the DNN model selected through the action by the agent. The energy overhead to be consumed through the selected action is the sum of the overhead required for inference of the reinforcement learning model to select the action and the overhead required for inference of the selected DNN model. The calculated energy overhead may vary depending on the first feature information of the state. If the agent determines that the budgeted overhead energy is unavailable, the agent recognizes an inference failure and does not initiate the inference. In the occurrence of an inference failure, the agent is designed to receive a negative penalty p as a reward.

If an inference failure does not occur, the agent receives a positive reward; Eq. 1 below shows the positive reward that the agent receives as the agent selects a model mₜ through an action at time step t.

$$IRER ( \text{?} ) \text{?} \vert \frac{Error Rate ( \text{?} ) - Error Rate ( \text{?} )}{Error rate ( \text{?} )} \vert \qquad [ Eq . 1 ]$$

$$\text{?} \text{indicates text missing or illegible when filed}$$

In Eq. 1, Error Rate(mₜ) represents the error rate of a DNN model selected at time step t, and Error Rate(mₘᵢₙ) represents the error rate of a DNN model showing the highest error rate among the plurality of DNN models.

The Increasing Rate of Error Rate (IRER) value is obtained as a reward, which is the ratio of the improvement in the inference result error rate achieved through the selected model mₜ to the inference result error rate of the model mₘᵢₙ with the simplest structure and the highest inference result error rate. In the energy harvesting environment, if the inference result regarding the energy use turns out to be inaccurate, the amount of wasted energy becomes significant; thus, a positive reward is designed in terms of the inference result error rate of the model.

Therefore, in a state where there are N inference requests in one episode, comprising N1 inference successes and N2 inference failures, the sum of the accumulated rewards that the reinforcement learning agent seeks to maximize is expressed by Eq. 2 below.

$$\text{?} = \text{?} IRER ( \text{?} ) + \text{?} = N - ( 1 - p ) {N}_{2} - \frac{1}{e} \text{?} Error ( \text{?} ) \qquad [ Eq . 2 ]$$

$$\text{?} \text{indicates text missing or illegible when filed}$$

In Eq. 2, N represents the number of inference requests within one episode, N₁ represents the number of inference successes, N₂ represents the number of inference failures, p represents the preconfigured hyperparameter value, and e represents the error rate of a DNN model with the highest error rate among the plurality of DNN models.

As can be seen from the right side of Eq. 2, maximization of the sum of accumulated rewards is achieved by minimizing both N₂ and Σ₁^{N}^{₁} Error Rate(mₜ). As a result, the maximization corresponds to minimization of both the inference failure rate and the average inference result error rate. Based on the preconfigured hyperparameter value of p, learning is carried out to maximize Eq. 2. In one embodiment, the Proximal Policy Optimization (PPO) algorithm may be employed for the reinforcement learning algorithm during the learning phase.

The reinforcement learning algorithm is empirically determined by experimenting with various structures, considering the energy overhead cost required to perform the model selection algorithm.

To evaluate the policy after completion of learning, a metric shown in Eq. 3 is used.

$$Metric = failrate + successrate * \overline{Error ( m )} \text{?}$$

$$\overline{Error ( m )} = \frac{\text{?} ( Error ( m ) )}{{N}_{1}}$$

$$\text{?} \text{indicates text missing or illegible when filed}$$

In Eq. 3, failrate represents the inference failure rate, successrate represents the inference success rate, N₁ represents the number of inference successes, and Error(m) represents the error rate of a selected DNN model.

Each term expressed in the metric is an average index of the two terms to be minimized in the sum of accumulated rewards divided by the total number of inference requests. The expected value of the sum of the two terms obtained during the learning process through episodes is used as a metric.

In one embodiment of the present disclosure, the operational sequence of an algorithm for selecting a model, which has completed learning, may be as shown in FIG. 1.

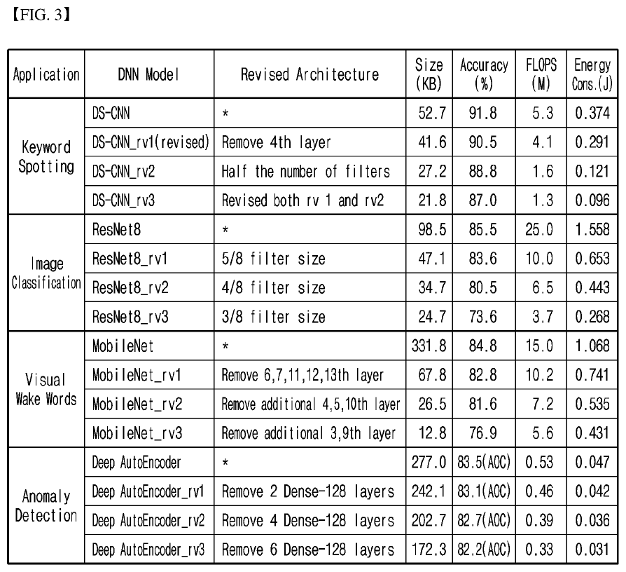

FIG. 3 is a table showing information of DNN models configured for an experiment according to one embodiment of the present disclosure.

The neural network models used for the experiment include DS-CNN, MobileNet, ResNet8, and Deep AutoEncoder. In conducting the experiment, the basic structure employed is the one with the greatest complexity, namely, the highest energy consumption and highest accuracy. In addition, models with a contracted network structure obtained by reducing the number of layers or filters are built for each application. All DNN models, having completed learning, are compressed through int8 quantization using the TensorFlow lite for micro (TFLM) framework. The datasets and input sizes used for learning include Speech Commands (49×10), Cifar10 (32×32×3), VWW Dataset (96×96×3), and ToyADMOS (5×128).

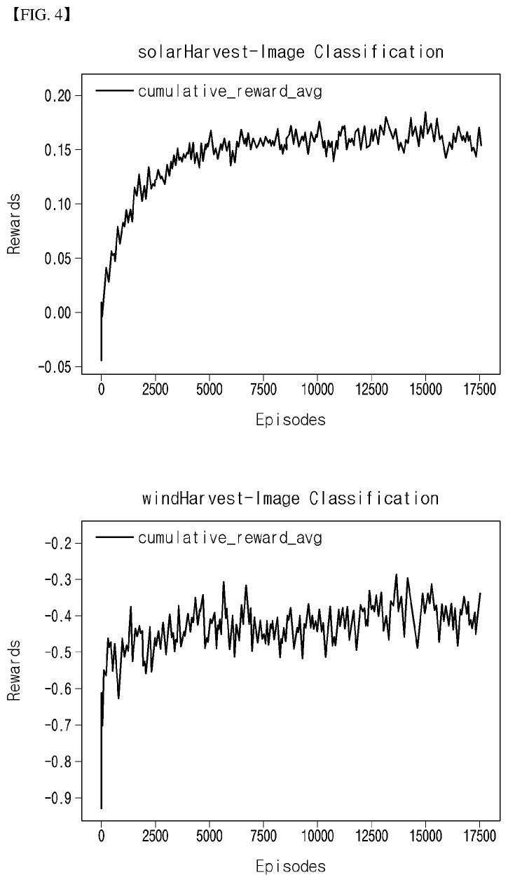

FIG. 4 are graphs showing the average rewards of reinforcement learning for model selection due to the difference between power sources for energy harvesting according to one embodiment of the present disclosure.

The upper figure shows a situation in which solar energy is used as a power source, and the lower figure shows a situation in which wind energy is used as a power source. The Proximal Policy Optimization (PPO) algorithm is used as the reinforcement learning algorithm.

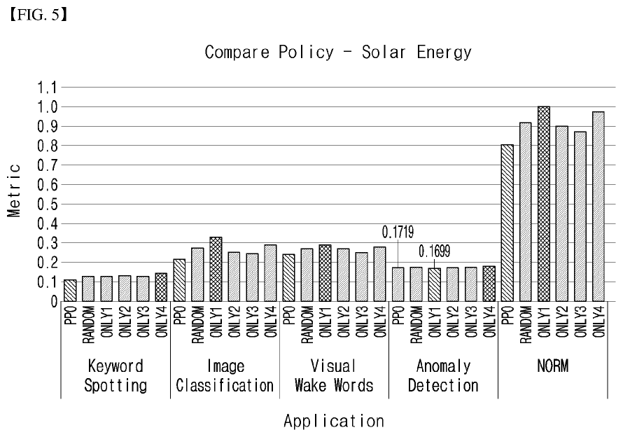

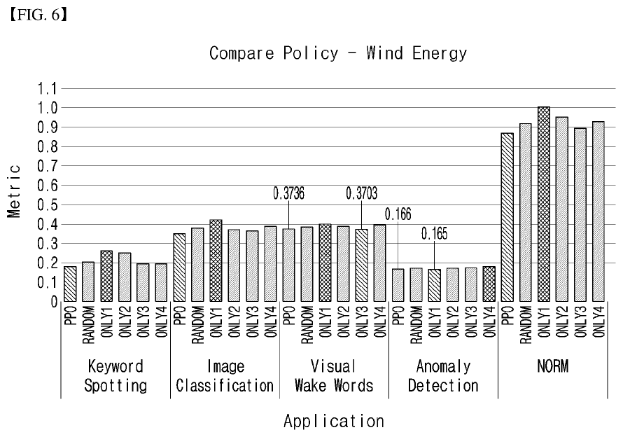

FIGS. 5 and 6 are graphs showing measurements of metric values for each application in situations where solar energy and wind energy are harvested according to one embodiment of the present disclosure.

To evaluate the performance of a reinforcement learning model with the selected structure, an experiment is conducted to compare the performance of a policy of randomly selecting a model and a policy of loading and using only one model. When the sum of metric values measured for four applications is normalized relative to the ONLY1 policy (the policy that loads and uses only a specific model), the reinforcement learning-based model selection policy achieves a score of 0.803694 when solar energy is used as the power source and a score of 0.862366 when wind energy is used as the power source.

Meanwhile, the embodiments of the present disclosure may be implemented in the form of computer-readable code in a computer-readable recording medium. A computer-readable recording medium includes all kinds of recording devices that store data that a computer system may read.

Examples of a computer-readable recording medium include a ROM, a RAM, a CD-ROM, a magnetic tape, a floppy disk, and an optical data storage device. Also, the computer-readable recording medium may be distributed over computer systems connected through a network so that computer-readable code may be stored and executed in a distributed manner. Functional programs, codes, and code segments for implementing the present disclosure may be easily inferred by those programmers in the technical field to which the present disclosure belongs.

Since various modifications may be implemented using the configurations and methods described and illustrated herein without departing from the scope of the present disclosure, all matters included in the detailed description above or shown in the accompanying drawings are introduced only for the illustrative purposes and do not limit the scope of the present disclosure. Accordingly, the scope of the present disclosure should not be limited by the exemplary embodiments described above but should be determined only by the appended claims and their equivalents.

What is claimed is:

1. An inference method using a DNN model in an energy harvesting system, the method comprising:
performing energy harvesting and storing energy in a storage;
receiving a request for inference using data collected during the period of energy harvesting;
selecting one DNN model to perform the inference among a plurality of DNN models;
performing the inference through the selected DNN model; and
performing energy harvesting again when the inference is completed and storing energy in the storage,
wherein the plurality of DNN models are DNN models with different inference accuracy and energy consumption required for inference, and
the selecting of the DNN model is performed by an agent through an action based on the state of energy stored in the storage.

2. The method of claim 1, wherein the performing of the inference through the selected DNN model includes:
refraining from the inference if it is determined that the amount of energy required to complete the inference through the selected DNN model is greater than the amount of energy stored in the storage; and
performing energy harvesting again and storing energy in the storage if the inference is not performed.

3. The method of claim 2, wherein the state of energy stored in the storage includes features corresponding to:
(a) information on the amount of energy stored in the storage,
(b) information on the amount of energy stored during the interval up to a previous time step,
(c) information on the average amount of energy stored during a period comprising last 10 time steps, and
(d) information obtained by subtracting the average value of the quantity of energy stored during a period comprising three oldest time steps from the average value of the quantity of energy stored during a period comprising three most recent time steps within a period comprising last 10 time steps,
wherein the agent performs the action based on the features (a) to (d).

4. The method of claim 2, wherein the policy is updated so that an accumulated sum of rewards received by the agent has the maximum value,
wherein the agent receives:
a ratio by which a first DNN model selected at a current time step among the plurality of DNN models is improved compared to a second DNN model with the highest error rate among the plurality of DNN models as a positive value, and
a preconfigured hyperparameter value as a negative reward when the performing of the inference is not performed.

5. The method of claim 4, wherein the positive reward is calculated using an equation below
$$IRER ( \text{?} ) = \vert \frac{Error Rate ( \text{?} ) - Error Rate ( \text{?} )}{Error rate ( \text{?} )} \vert ,$$
$$\text{?} \text{indicates text missing or illegible when filed}$$
wherein Error Rate(mₜ) represents the error rate of a DNN model selected at time step t, and Error Rate(mₘᵢₙ) represents the error rate of a DNN model showing the highest error rate among the plurality of DNN models.

6. The method of claim 5, wherein an accumulated sum of rewards received by the agent is calculated by an equation below
$$\text{?} = \text{?} IRER ( \text{?} ) + \text{?} p = N - ( 1 - p ) {N}_{2} - \frac{1}{\text{?}} \text{?} Error ( \text{?} ) ,$$
$$\text{?} \text{indicates text missing or illegible when filed}$$
wherein N represents the number of inference requests within one episode, N₁ represents the number of inference successes, N₂ represents the number of inference failures, p represents the preconfigured hyperparameter value, and e represents the error rate of a DNN model with the highest error rate among the plurality of DNN models.

7. The method of claim 4, wherein evaluation of the policy which has been updated uses a metric shown in an equation below
$$Metric = failrate + successrate * \overline{Error ( m )} \text{?}$$
$$\overline{Error ( m )} = \frac{\text{?} ( Error ( m ) )}{{N}_{1}} ,$$
$$\text{?} \text{indicates text missing or illegible when filed}$$
wherein failrate represents the inference failure rate, successrate represents the inference success rate, N₁ represents the number of inference successes, and Error(m) represents the error rate of a selected DNN model.

8. A recording medium readable by a digital processing device, in which a program of commands executed by the digital processing device to provide inference using a DNN model in an energy harvesting system is implemented, recording a program for executing a method of claim 1 in a computer.
